(19) United States
(12) Patent Application Publication
(10) Pub. No.: US 2016/0189753 A1
(43) Pub. Date: Jun. 30, 2016

(54) SYSTEM AND PROCESS FOR CREATING MULTIPLE UNIQUE VERSIONS OF A VIDEO FOR PLACEMENT ON UNIQUE GENERATED WEB PAGES AND VIDEO-SHARING WEB SITES

(71) Applicants: Robert William Mangold, Phoenix, AZ (US); Paul Harold Dunn, Tucson, AZ (US)

(72) Inventors: Robert William Mangold, Phoenix, AZ (US); Paul Harold Dunn, Tucson, AZ (US)

(21) Appl. No.: 15/067,109

(22) Filed: Mar. 10, 2016

Related U.S. Application Data
(63) Continuation-in-part of application No. 14/296,104, filed on Jun. 4, 2014.

(51) Int. Cl. G11B 27/036; H04N 21/2343; H04N 21/858; H04N 21/2743

(52) U.S. Cl. CPC G11B 27/036; H04N 21/2743; H04N 21/23439; H04N 21/858

(57) ABSTRACT

A video creation system and process that allows users to create multiple unique versions of a video is disclosed. The system allows online marketers, online SEO management firms, online business owners, small business owners, and other users to create multiple unique versions of a video that can be used for promotional purposes online using a set of chosen keywords. Each video is unique by varying the length, progression, audio, metadata or search terms, video descriptions, and information about where the video was geographically produced. By performing the video creation process, the video creation system greatly reduces the time it takes to generate multiple unique versions of a single source video. The generated multiple unique versions of the video are published as unique generated web pages and may be placed on video-sharing web sites and any other website that can accept video.

### CROSS REFERENCE TO RELATED APPLICATION

This application is a continuation-in-part of Ser. No. 14/296,104, pending, filed Jun. 4, 2015, by Mangold et al. and entitled “SYSTEM AND PROCESS FOR CREATING MULTIPLE UNIQUE VERSIONS OF A VIDEO,” which claims priority to U.S. Provisional Patent Application Ser. No. 61/832,589, filed Jun. 7, 2013, each of which is incorporated herein by reference in its entirety.

### BACKGROUND OF THE INVENTION

1. Field of the Invention

Embodiments of the invention described in this specification relate generally to creating videos, and more particularly, to generating multiple unique versions of a video for placement on unique generated web pages and any other website that can accept video.

2. Description of the Related Art

The use of online video to market products and services is growing. However there is a fairly large barrier which is preventing the average person or business from using online video for marketing their products and or services.

That barrier exists for any of several reasons that are based on what people believe is true for making online videos. For instance, many people believe it is too hard to make videos, that it is too expensive to make videos, or that it will take too much time to make videos. People also have other reasons which add to this barrier, including not liking how they appear or sound on a video recording, not knowing what to say or how to act while recording a video, and not knowing what equipment to buy, rent, borrow, or otherwise use in making videos. Additionally, a typical person or business does not know what to do with a video once it is produced. For instance, many people would be stumped if asked where or how they plan to distribute their videos. Similarly, many people may not know how to properly optimize a video for online marketing and search engine results.

Another factor is that most people do not understand technical aspects of video recording and production. For instance, many people do not have any understanding or only limited understanding of what is involved in editing a video. Typical people are busy and do not take the time to learn about video production and/or editing, and most people do not buy the tools to learn.

Adding to this general lack of understanding of video production, editing, and distribution, is a general lack marketing knowledge as it relates to online (i.e., Internet) video. Specifically, most people do not know or understand that in order to be found online for a multitude of search terms, a marketer must have a substantial amount of videos available online (e.g., several different unique versions of the original video). Generally, each video a marketer makes is found for one specific search term. In order for a business to be found online, they need to have hundreds or thousands of videos for all the various search terms a potential customer may type into a search engine, and each video must be unique and not simply a copy of the original video.

Those people who realize that multiple videos are needed to cross reference against multiple search terms that relate to a business typically fail to appreciate how such multiple videos can possibly be created. In general, people believe that making more than just a few videos will take a substantial investment of time and money.

Unfortunately, existing systems and software that are used in building videos are suitable for casual users but do not meet professional standards that are required in videos for online marketers, online Search Engine Optimization management firms, online business owners, and/or small business owners. Typically, the existing options provide a “one at a time” process for making videos one at a time. This makes it nearly impossible for a marketer, or other entity in need of a large quantity of individually unique videos, to create enough of the videos in a reasonable period of time. The quantities needed can be unlimited, because the number of videos should at least cover all the various terms that a potential customer would use to search for a business online in order to do their marketing efficiently.

Therefore, what is needed is a way for online marketers, online Search Engine Optimization management firms, online business owners, small business owners, and other people or entities (hereinafter referred to as a “user” or “users”) to create multiple unique versions of a video image sequence, each of which can be associated with a keyword that might be likely to be used in a search, in order to promote a product, service, business, or other item online.

### SUMMARY OF THE INVENTION

Some embodiments of the invention include a novel system that creates one or more unique versions of a video based on user-supplied content (e.g., multiple image and/or short mp4 files). In some embodiments, the source set of images is associated with video content when the set of images are viewed as a sequence during playback. In some embodiments, the system associates each unique video version with one or more search term keywords for widespread online distribution of the video content. In some embodiments, the system connects a server computing device, which creates the unique video versions, to a user computing device, which provides the source set of images. In some embodiments, the system produces each unique version of the video by varying at least one of the length of the unique video version, the sequence of images and/or video that progress throughout playback of the unique video version, audio that is integrated into the unique video version, metadata that is associated with the unique video version, search terms that are associated with the unique video version, a video description that is associated with the unique video version, and geolocation data related to where the unique video version was produced.

The system can produce an unlimited number of unique videos from the source set of images and/or video in an easy user-friendly manner, thereby removing barriers related to adoption of video by users. In particular, the barrier of time is eliminated by the system because unique video versions of the source set of images can be created in just a few minutes instead of the many hours or even days most users believe will be required.

In some embodiments, a novel process for creating multiple unique versions of a video based on a source content is performed by the system. In some embodiments, the process (i) receives a set of variational items that are used to ensure that each created video version is unique, a selection of an output type, and a number of unique video versions to create, (ii) creates the number of unique video versions by varying at least one of a sequence of progression for the source set of images and/or video and a variational item from the set of variational items, and (iii) outputs each unique video version according to the selected output type.

In some embodiments, the process receives the set of variational items from the user computing device. In some embodiments, the set of variational items include a plurality of images and/or video, a set of audio clip selections, universal resource location (URL) addresses of promotional content, addresses for the video production, a set of video descriptions in textual format, and a set of search term keywords to associate with the unique video versions.

In some embodiments, the process allows the unique videos to be automatically uploaded to one or more video-sharing websites (e.g., YouTube). In other embodiments, alternatively or additionally, the user can be provided with video files storing the unique videos for manual uploading onto any website that allows such videos to be shown. In various embodiments, the system can alternatively or additionally create a unique web page for each of the unique videos wherein the created web pages include the unique videos. The created web page can further include various tags and keyword titles to allow for search engine recognition. In addition, a separate lead web page can be created having information useful for sales lead generation and contact information. As an example, the lead page may include a contact form for requesting additional information, a link to a landing page website, and a contact telephone number. The created web pages can be published to a web site having many such web pages for various other users.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for creating multiple unique versions of a video in some embodiments.

FIG. 2 is a continuation of the process illustrated in FIG. 1.

FIG. 3 conceptually illustrates a schematic view of an architecture of a system that creates multiple unique versions of a video in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system that creates one or more unique versions of a video based on a source set of images and/or video. In some embodiments, the source set of images is associated with video content when the set of images are viewed as a sequence during playback. In some embodiments, the system associates each unique video version with one or more search term keywords for widespread online distribution of the video content. In some embodiments, the system connects a server computing device, which creates the unique video versions, to a user computing device, which provides the source set of images and/or video. In some embodiments, the system produces each unique version of the video by varying at least one of the length of the unique video version, the sequence of images and/or video that progress throughout playback of the unique video version, audio that is integrated into the unique video version, metadata that is associated with the unique video version, search terms that are associated with the unique video version, a video description that is associated with the unique video version, and geolocation data related to where the unique video version was produced.

As stated above, the use of online video to market products and services is growing, but there are many barriers that prevent large scale adoption of video by businesses, marketers, SEOs, and others. Embodiments of the invention described in this specification solve such problems by allowing a user to simply upload images and/or video (e.g., short mp4 files) and either select audio tracks from an audio library accessible to user online or upload audio tracks from a personal computing device and/or data storage, and then indicate how many unique versions of the video to create. In this way, the system and process of some embodiments enables users to create multiple unique versions of a video in just a few minutes. Each video may vary in length, vary in the images it displays, vary in the image progression, vary in the audio track as well as set a physical geographic location where the video was created. Having several unique versions of a single video is extremely important to being found online by potential customers using a variety of search terms to find a product or service.

The system can produce an unlimited number of unique videos from the source set of images and/or video in an easy user-friendly manner, thereby removing barriers related to adoption of video by users. In particular, the barrier of time is eliminated by the system because unique video versions of the source set of images and/or video can be created in just a few minutes instead of the many hours or even days most users believe will be required.

### I. Process for Creating Unique Versions of A Source Video

In some embodiments, a novel process for creating multiple unique versions of a video based on a source set of images is performed by the system. In some embodiments, the process (i) receives a set of variational items that are used to ensure that each created video version is unique, a selection of an output type, and a number of unique video versions to create, (ii) creates the number of unique video versions by varying at least one of a sequence of progression for the source set of images and a variational item from the set of variational items, (iii) outputs each unique video version according to the selected output type, and (iv) publishes each of the unique videos to generated unique web pages.

In some embodiments, the process receives the set of variational items from the user computing device. In some embodiments, the set of variational items include a plurality of images and/or video, a set of audio clip selections, universal resource location (URL) addresses of promotional content, addresses for the video production, a set of video descriptions in textual format, and a set of search term keywords to associate with the unique video versions.

In some embodiments, the plurality of images and/or video comprises three sets of images and/or video. Each set of images and/or video corresponds to a set of temporal video positions associated with a set of playback positions along a timeline associated with playback a unique video version. In some embodiments, the three sets of images and/or video comprise a first set of images and/or video that corresponds to a set of temporal video positions associated with a beginning section of the unique video version, a second set of images and/or video that corresponds to a set of temporal video positions associated with a middle section of the unique video version, and a third set of images and/or video that corresponds to a set of temporal video positions associated with an ending section of the unique video version.

In some embodiments, the set of audio clip selections to use as audio production tracks comprises at least one of a set of audio clips selected from an audio library and a set of audio clips selected from the user computing device to upload to the server computing device. In some embodiments, each URL comprises the address of a website from which the promotional content can be accessed. In some embodiments, the addresses for video production are physical addresses of the video production.

In some embodiments, the process is implemented as a software application that includes sets of instructions for performing operations of the process when the software application is running on a processor of a computing device. In some embodiments, the software application runs on the server computing device. In some embodiments, the user computing device accesses a web server associated with the server computing device over the Internet to interface with the software application running on the server computing device. In some embodiments, the audio library is stored in a database of a data storage device that is accessible to the software application running on the server computing device. In some embodiments, the database is accessible through adatabase management system running on the server computing device. In some embodiments, the database is a cloud database accessible through a cloud database management system.

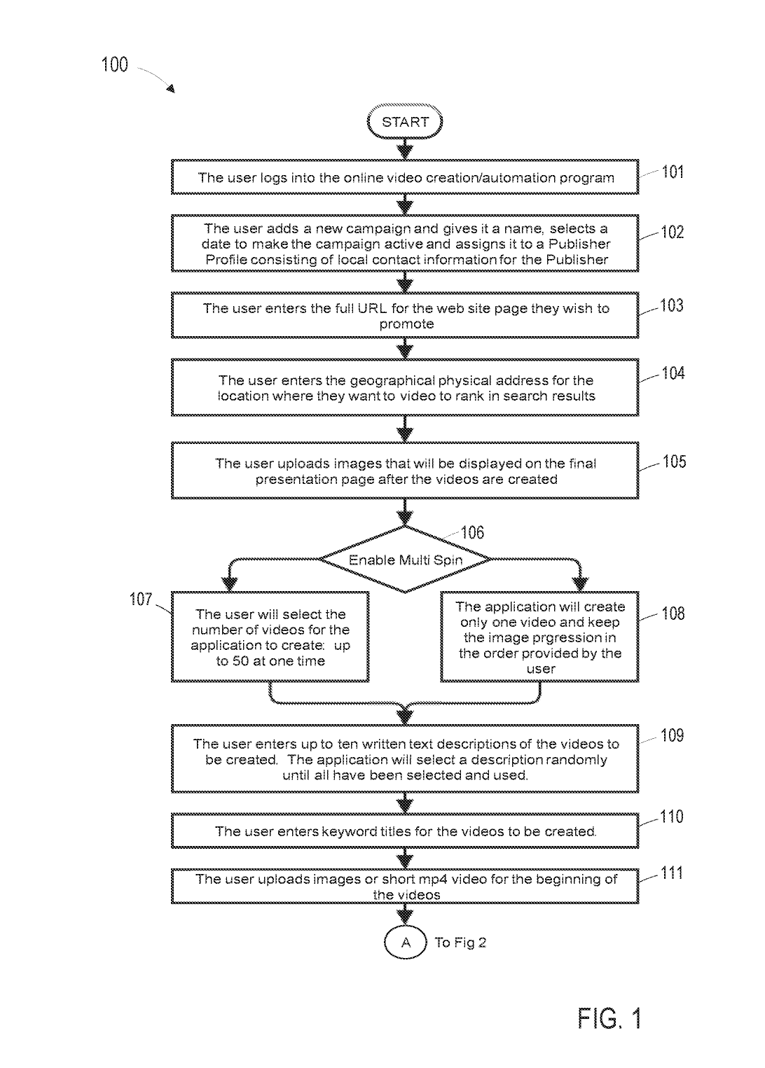

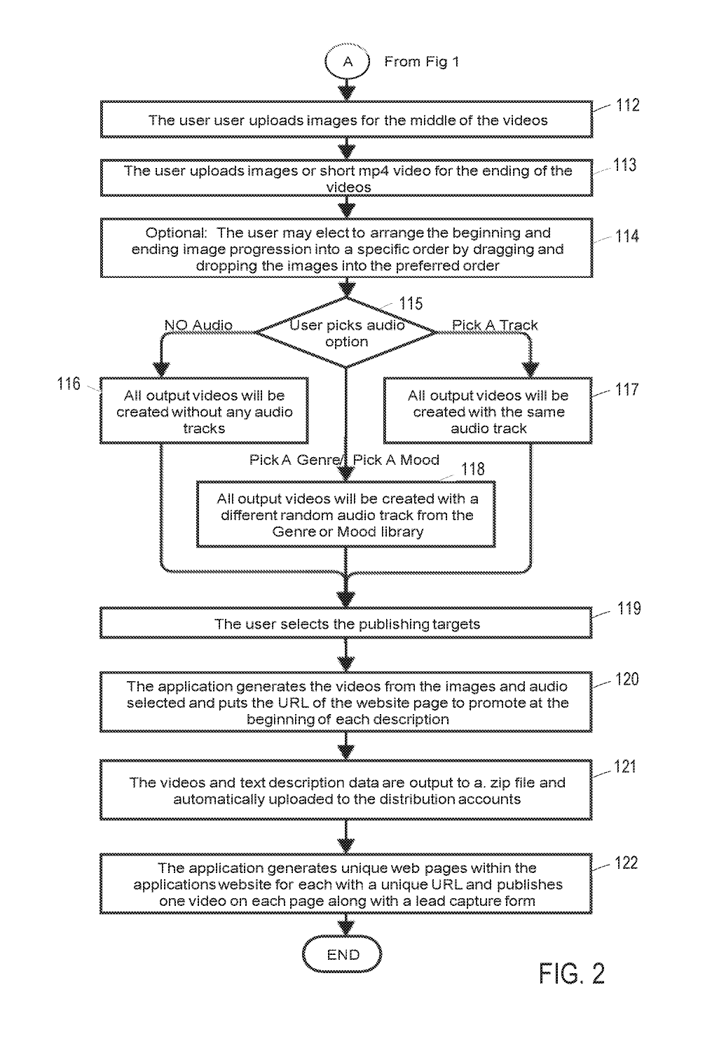

FIGS. 1 and 2 conceptually illustrates an exemplary process 100 for creating multiple unique versions of a video in some embodiments. The process 100 is performed by the software application running on the server computing device of the system in some embodiments. The software application is a video creation/automation program in some embodiments. As shown in FIG. 1, the exemplary process 100 starts when a user logs into (101) the video creation/automation program. For example, the user may provide login credentials such as a user id and password to access the operational features of the video creation program.

Once logged into the video creation program, the user adds a new campaign (102) and gives it a name, selects a date to make the campaign active and assigns it a publisher profile comprising local contact information for the publisher. Next, the user enters the address (i.e., URL) (103) for the web site page they wish to promote. As stated above, one of the reasons that video is distributed on the Internet is to promote a service, a product, a business or organization, an event, or anything to which a marketer may intend to drive traffic. Thus, when the user enters a URL as a web page for promotion, the video creation program inserts a redirection code into a metadata field of the video to have the video-hosting web page redirect a viewer of the video to the promotional web page. The user may also enter the physical geographic address (104) for the location where they want the video to rank in search results. The user may select a location on a map that is displayed by the video creation program or may enter a physical address (i.e., number, street, city, etc.). In some cases, the source video may include embedded metadata that includes GPS coordinates of a location at which the video is stated to have been captured and/or produced. In some embodiments, the user may provide a list of multiple different locations which the video creation program can use to vary over the number of unique video versions to be created. Whatever the format of the physical address, in some embodiments, the video creation program converts the format to a set of latitude and longitude coordinates or some other common geo-location format.

The user then uploads images (105) that will be displayed on the final presentation page after the videos are created. In some embodiments, the user has a choice as to whether to enable the “multi spin” feature (106). If the multi-spin feature is enabled, the user will select the number of videos for the application to create. In some embodiments, the number of videos can be quite large, e.g., 50 videos. If the multi-spin feature is not enabled, the application will create only one video and keep the image progression in the order provided by the user (108). Next, the user enters a number of written text descriptions, e.g., ten such descriptions, of the videos to be created (109). The application will select a description randomly until all have been selected and used. The written descriptions include summary descriptions to be associated with the unique video versions that get created by the system. For example, ten written descriptions of the video may be entered by a user or provided by the user in a list, with each written description summarizing the video content differently from the other descriptions. In some embodiments, when the user enters multiple differing written descriptions, the process outputs the written descriptions for associations with the unique video versions in a round robin manner. Next, the user enters keyword titles (110) for the videos to be created. Specifically, the process receives a set of keyword tags to associate with the unique video versions being created. The user may have a set of keywords to use, and thus, enters them into the video creation program at this step. Alternatively, the user may employ the assistance of a keyword helper tool of the video creation program. The keyword helper tool helps users select keywords and tags for optimizing videos for online marketing and search.

The user can now start uploading the three sets of images and/or videos. The video creation program allows a user to create a “beginning”, “middle”, and “ending” for their unique videos. Both the “beginning” and “ending” sections are there to help a user “brand” their business, service, or products, and these sections can potentially be the same for any and all videos that the user may create. The “middle” section of images includes the bulk of the substantive video content which the user intends to create. Also, the “middle” section typically includes the majority of the images that are added and randomized for different lengths and different image sequence progressions, thereby ensuring that every video version that gets created is unique. In some embodiments, the process 100 receives (111) uploaded images or a short mp4 video for the beginning of the videos, (112) uploaded images for the middle of the videos, and (113) uploaded images or a short mp4 video for the ending of the videos. Although the sequence of receiving the three sets of user-supplied content is described in a particular order (i.e., beginning, middle, ending), the user can upload the content in a different order. The user can control this order because the video creation program in some embodiments is interactive. Thus, the user may select different menu items or graphical user interface (GUI) tools to start uploading each of the three sets of content. For example, the user may select a GUI tool, such as a web page button or control, to upload the ending content first, then select a different GUI tool to upload the middle content second, and finally, select another GUI tool to upload the starting content. In some embodiments, a single GUI tool or menu item is used for uploading each of the three sets of content, with the user indicating which of the three sets is being uploaded (e.g., beginning, ending, or middle set). In general, no particular order of uploading is required for the process 100 to work. Furthermore, it is to be understood that in some embodiments, the sets user-supplied content could be divided into either fewer or greater than three such sets. Additionally, the user may optionally elect (114) to arrange the beginning and ending progression into a specific order by, for example, dragging a dropping the images or video snippets into the preferred order.

Next, the process 100 allows the user to select an audio option (115). The user may elect (1) to not have audio (116) in which case all output videos will be created without any audio tracks, (2) to pick an audio track (117) in which case all output videos will be created with the same audio track. Or (3) to pick a genre or mood (118) in which case all output videos will be created with a different random audio track from the Genre or Mood Library. The audio clips can be obtained from a data storage device connected locally to user computing device or from a cloud-based data storage service. In some embodiments, the user selects the audio clips to use as audio production tracks from an audio library that is accessible through the video creation program. When the user uploads audio clips or selects audio clips from the audio library, the video creation program provides a tool for listening to each audio clip to determine if it should be included in the production. The user then sets a parameter for audio clips to be used as production audio tracks for the unique video versions. For example, a GUI window of the video creation program may include a production audio track column or box in which audio clips selected for final production can be referenced (e.g., by dragging and dropping an audio clip file name into the column or box).

Next, the user selects the publishing targets (119). The application then generates the videos (120) from the user-supplied content and audio selected, and puts the URL of the website to promote at the beginning of each description. The videos and text descriptions are outputted (121) to files (e.g., a .Zip file) and/or automatically uploaded to the distribution accounts (if desired). Examples of online video hosting services include YouTube, DailyMotion, MetaCafe, Vimeo, and others. Finally, the application generates unique web pages within the application's website for each created video with a unique address (e.g., URL) and publishes one video on each such page as well as a lead capture form.

Thus, by performing the process 100, the video creation/automation program allows users to create hundreds or thousands of videos in a short period of time, thereby enabling the user to be found by potential customers who are searching for their product online by using hundreds or even thousands of different search terms. In this way, the video creation program, running on a server computing device of the system and performing the process 100, removes all the barriers users face in making online videos and using those videos to market their products and or services.

### II. Video Creation System

The video creation system of some embodiments allows a user to create multiple unique versions of a video that they can then take and promote online for their chosen keywords. What makes a video unique is the varying length, varying image progression, varying audio, varying metadata or search terms, and varying video descriptions as well as a description of where the video is stated to have been geographically produced. It greatly removes the barrier of time and takes just a few minutes to do what other systems would take many hours or even days to accomplish.

The video creation system of the present disclosure may be comprised of the following elements. This list of possible constituent elements is intended to be exemplary only and it is not intended that this list be used to limit the video creation system of the present application to just these elements. Persons having ordinary skill in the art relevant to the present disclosure may understand there to be equivalent elements that may be substituted within the present disclosure without changing the essential function or operation of the video creation system.

1. A computer server with FFmpeg installed

2. A connection to the Internet (i.e., the cloud)

3. A client computing device, such as a computer, laptop, notebook, or tablet with Internet connectivity and audio and image capability

4. Image content

5. Audio content

6. Digital camera to capture image content

7. Audio content library installed on server

8. Web Server for hosting a website having web pages for each created unique video.

The various elements of the video creation system may be related in the following exemplary fashion. It is not intended to limit the scope or nature of the relationships between the various elements and the following examples are presented as illustrative examples only. A digital camera to capture image content (6) is connected to the client computing device (3). The client computing device (3) is connected to a public network, such as the Internet (2). A computer server with FFMPEG installed (1) and the video creation program installed. The computer server (1) also is connected to the Internet (2).

The user is able to access the computer server (1) through the cloud (Internet) and perform video creation operations via the video creation program installed on the server where the user can upload user-supplied content (e.g., multiple image and/or video content) (4) files, multiple audio content (5) files or select multiple audio files from the software's audio content library (7) installed on the server (1) for inclusion in the unique video versions to be created. The user also inputs other metadata information as described by reference to FIGS. 1 and 2, above.

The video creation program then takes the images/video and audio and generates the number of requested unique videos selecting variable numbers of image content (4) and audio content (5) and provides the user with a download button where the user can click and download a zip file containing the unique videos generated as well as a text file with the descriptions and tags the user entered earlier. Optionally, the user may select to have the output automatically uploaded to one of the online video hosting platforms, such as YouTube, DailyMotion or Vimeo. With this option selected, the user would enter their online video hosting platform user ID and password into the video creation program. Then the video creation program accesses the user's online video hosting platform's account through the Internet (2) and uploads the unique videos and text data, descriptions and tags the user entered earlier to the user's online video hosting platform. Additionally, the video creation program creates a unique web page for each of the unique videos wherein the created web pages will include the unique videos. A lead web page can also be created having information useful for sales lead generation and contact information. The created web pages, including the lead page, can be web pages forming part of an expansive web site hosted on the server (1) (or elsewhere).

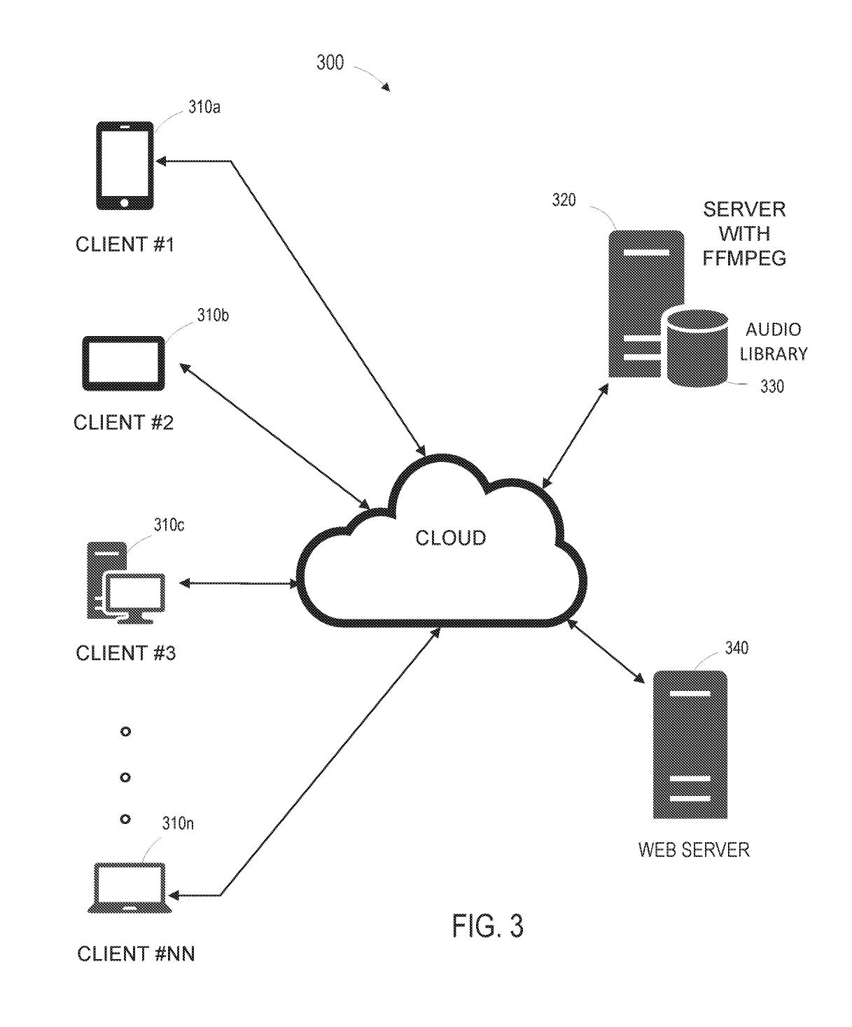

FIG. 3 conceptually illustrates a detailed schematic view of an architecture of a system 300 which is used in the creation of multiple unique versions of a video. As shown in this figure, the system 300 includes a plurality of client computing devices 310a-310n, a first server 320 and an audio library 330, and a second server 340. The first server 320 in some embodiments of the system 300 supports FFmpeg and runs the video creation program for the client computing devices 310a-310n to access for video creation. The first server 320 is also connected to a data storage device that includes the audio library 330. The second server 349 is a web server capable of hosting a website including web pages published for each of the unique generated videos as disclosed herein. In other embodiments, the same server can be used for hosting the website and for creating the video.

Each of the client computing devices 310a, 310b, 310c, and 310n connects to the server 320 over a network (labeled “cloud” in the system 300 in this figure), such as the Internet, to send and receive data (e.g., image data, mpeg4 data, decision data, etc.). In some embodiments, the image data and mpeg4 data is temporarily stored in one or more databases (not shown) and/or folders on the server 320. In some other embodiments, the server 320 does not store any client's image and mpeg4 data, but instead processes the received image data on-the-fly to generate the unique videos. When the system 300 works in real time to process a client's image and preference data, the server 320 may generate a copy of a unique version of a video and transmit the unique copy of the video back to the client. In some embodiments, the server 320 generates multiple unique versions of a video from the images received from a client. When multiple unique versions of the video are generated, the server ensures that the user-specified decisions and preference data is used in creating each video in a manner that is unique compared to the other generated videos. In this way, all copies of a video which the server 320 generates for a client will be unique.

Additionally, the server 320 can generate an unlimited number of unique copies of a video from the sets of received images and/or video, but hardware or software limitations may limit the ability of the server to generate all such copies in real-time. In some embodiments, each unique copy of a video is generated in sequence, one after another. In some other embodiments in which the server 320 includes multiple processors or software that is multi-threaded, multiple unique video versions may be contemporaneously generated. The server 320 of some embodiments may transmit the generated unique video versions back to the client in batch form after the user selects to download them (when automatic posting to an online video hosting service or platform is disabled), after all copies are generated or may transmit each unique version of the video back to the client when the server 320 completes generation of the unique video version.

The system 300 of the present disclosure generally works by user interaction with any of the client computing devices 310a-310n. The client computing device runs a browser program or a proprietary client software application that connects to the server and initiates the video creation program (which implements the process 100) by user login to the system 300. In particular, the user will use the client computing device to interact with a graphical user interface (GUI) displayed in the browser or client software application. For example, the GUI may be a Java powered user interface located on the server and provided to the browser application or client software application for display on display screen of the client computing device. When the user uploads the three sets of images and/or video for the beginning of the videos, the middle of the videos, and the ending of the videos, the video creation program on the server converts all images to a common image file format, such as JPEG, PNG, etc. The video creation program may also re-size the images and store them in a temporary folder on the server computing device or a data storage device accessible to the server computing device. The images are then sequenced according to the user-specified variations decided upon. Also, when the number of unique video versions are generated, they may be stored temporarily in file folders and/or a database. The generated unique videos are then published as separate web pages to a website hosted on the server 340. However, in addition to removing all of the user-provided images, the system of some embodiments also removes all of the unique video versions after completion of the process.

### III. Electronic System

Many of the above-described features and applications are implemented as software processes that are specified as a set of instructions recorded on a non-transitory computer-readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

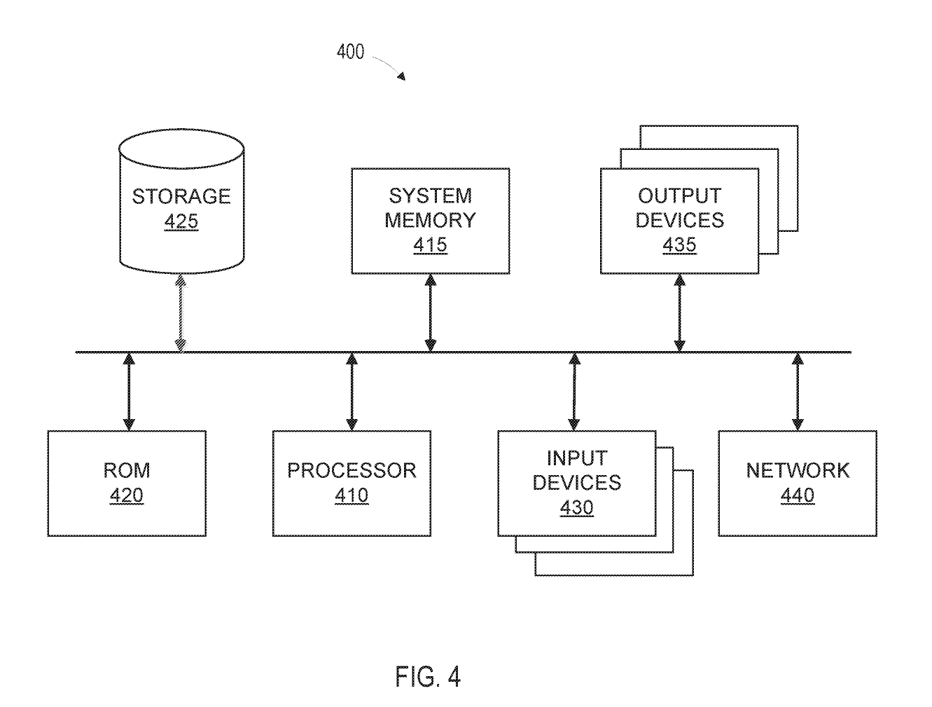

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a nonvolatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW,etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 2 conceptually illustrate a video creation process. The specific operations of this process may not be performed in the exact order shown and described. Specific operations may not be performed in one continuous series of operations, and different specific operations may be performed in different embodiments. Furthermore, the process could be implemented using several sub-processes, or as part of a larger macro process.

Also, while several embodiments of the video creation system and process have been described in relation to FIGS. 1-3, it is understood that other embodiments of the system and process are disclosed by their common features and/or functionality. For instance, the software of the system and process could be used for search engine optimization, public relations, advertising, education training, starting a local business video company, and content distribution. Similarly, the software is very well suited for general purpose marketing. Also, embodiments of the system and software can be adapted to create and kind of video content (e.g., live streaming video content, animated content, realistic video content, etc.), content for distributing online, news media, sales media, public relations media, search engine content, blog content, etc. Thus, one of ordinary skill in the art would understand that the invention is not to be limited by the foregoing illustrative details, but rather is to be defined by the appended claims.

What is claimed is:

1. A method for video creation, comprising:
receiving a plurality of content to use in the unique versions of the video;
receiving a set of variational parameters that ensure that each of the videos to create is unique from the other videos in the plurality of unique videos;
receiving a set of keywords to associate with the plurality of unique versions of the video to allow for promotion of one or more of a business, an organization, a product, a service, a person, and an event; and
publishing each unique generated version of the video to a respective web page.

2. The method of claim 1, further comprising associating at least one keyword from the set of received keywords to each unique version of the video that is generated.

3. The method of claim 1, further comprising outputting each unique generated version of the video to a respective file.

4. The method of claim 1, further comprising uploading each unique generated version of the video to a public web-sharing site.

5. A non-transitory computer readable medium storing a program which, when executed by at least one processing unit of a computing device, creates a plurality of unique versions of a video, said program comprising sets of instructions for:
receiving a plurality of content to use in the unique versions of the video;
receiving a set of variational parameters that ensure that each of the videos to create is unique from the other videos in the plurality of unique videos;
receiving a set of keywords to associate with the plurality of unique versions of the video to allow for promotion of one or more of a business, an organization, a product, a service, a person, and an event; and
publishing each unique generated version of the video to a respective web page.

6. The non-transitory computer readable medium of claim 5, wherein the program further comprises a set of instructions for associating at least one keyword from the set of received keywords to each unique version of the video that is generated.

7. The non-transitory computer readable medium of claim 5, wherein the program further comprises a set of instructions for outputting each unique generated version of the video to a respective file.

8. The non-transitory computer readable medium of claim 5, wherein the program further comprises a set of instructions for automatically uploating each unique generated version of the video to a public web-sharing site.

9. A video creation and distribution system, comprising:
a server computing device connected to a network and comprising a processor, a data storage device, a multimedia encoding and decoding software package that includes a set of software libraries and a set of programs for handling multi-media content, and a video creation program that is stored on the data storage device and, when run on the processor of the server, creates a plurality of unique versions of a video based on a plurality of user-supplied content and a set of variational parameters;
a storage device comprising a set of audio clips that are integrated into the plurality of unique versions of the video;
a web server that hosts a website including web pages for each of the unique versions of the video;
a client computing device connected to the network and comprising a processor and a client software application that interfaces with the video creation program of the server computing device over the network and allows a user to provide the content and the set of variational parameters to the video creation program to create the plurality of unique versions of the video, wherein the user interacts with the client software application (i) to select the set of audio clips that are integrated into the plurality of unique versions of the video and (ii) to interface with the video creation program in order to select the content and the set of variational parameters used in generating the plurality of unique versions of the video.

10. The system of claim 9, wherein the storage device is connected to the server computing device and comprises an audio content library that includes the set of audio clips.

11. The system of claim 9, wherein the storage device is connected to the client computing device.

12. The system of claim 9, wherein the multimedia encoding and decoding software package comprises FFmpeg.

13. The system of claim 9, wherein the client computing device is one of a personal computer, a laptop computer, a tablet computing device, and a hand-held mobile computing device.

14. The system of claim 9, wherein the user-supplied content comprises a first set of beginning content, a second set of ending content, and a third set of middle content.

15. The system of claim 14, wherein the first set of beginning content and the second set of ending content comprise image content for branding at least one of a business, an organization, a service, a product, a person, and an event.

16. The system of claim 14, wherein the third set of middle content comprises substantive content that are randomized in the plurality of unique versions of the video according to at least one of length and progression of sequence.

17. The system of claim 9, wherein the set of variational parameters comprises a set of audio clips, a set of universal resource location (URL) addresses of promotional content, a set of physical video production addresses, a set of textual video descriptions, and a set of search term keywords to associate with the unique video versions.
